(19) United States
(12) Patent Application Publication
(10) Pub. No.: US 2013/0327579 A1
(43) Pub. Date: Dec. 12, 2013

(54) Method And Apparatus For Measuring The Weight Of A C-130 Aircraft With Jack-Screw Retraction Mechanism For The Main Landing Gear

(71) Applicant: C. Kirk Nance, Keller, TX (US)

(72) Inventor: C. Kirk Nance, Keller, TX (US)

(21) Appl. No.: 13/911,603

(22) Filed: Jun. 6, 2013

Related U.S. Application Data
(60) Provisional application No. 61/656,726, filed on Jun. 7, 2012.

(51) Int. Cl. G01G 19/08; B64C 25/00

(52) U.S. Cl. CPC G01G 19/08; B64C 25/00
USPC 177/1; 29/426.1; 177/136

(57) ABSTRACT

A method and apparatus for determining the weight of a C-130 aircraft with jack-screw landing gear compression loads applied to a C-130 aircraft main landing gear strut jack-screw friction washer. For each main landing gear, a thru-hole load cell is mounted to the bottom of the jack-screw so that the weight of the aircraft bears on the load cell. The load cells are connected to a computer which measures the loads and determining the weight and center of gravity of the aircraft.

This application claims the benefit of application Ser. No. 61/656,726, filed Jun. 7, 2012.

### FIELD OF THE INVENTION

The present invention relates to aircraft weight measuring methods and apparatuses.

### BACKGROUND OF THE INVENTION

There are many critical factors the pilot of an aircraft must consider when determining if the aircraft is safe for take-off. One of those factors is identifying the proper weight and center of gravity for the aircraft.

Aircraft are commonly supported by a plurality of compressible, telescopic landing gear struts. These landing gear struts contain pressurized hydraulic fluid and nitrogen gas. The weight of the aircraft rests upon and is supported by these “pockets” of compressed nitrogen gas, within the landing gear struts.

These landing gear systems are retracted into the airframe as the aircraft transitions into flight. Typically the landing gear is hinged to the aircraft wing structure, and hydraulic actuators are used to rotate the landing gear at the hinge point, to fold the landing gear as it transitions inside the aircraft wing and/or aircraft hull.

In the case of the C-130 aircraft, of which the C-130 aircraft is still in production today, the landing gear retraction system is that of an original 1954 design vintage; and that design has not been changed for over 50 years. The C-130 landing gear system is not hinged, to fold the landing gear into the aircraft, but instead is attached to the aircraft with a “vertical” jack-screw mechanism. The jack-screw mechanism raises and lowers the landing gear into and from the aircraft hull by using a reversible electric motor to rotate a long screw-shaft attached to the landing gear strut, where the screw-shaft will allow the vertical travel of the landing gear strut.

When measuring the weight of the C-130 aircraft, the aircraft weight can be classified into two types. The first type of weight is commonly referred to as “sprung weight.” The sprung weight is the vast majority of the aircraft weight and is supported and suspended above the landing gear. The second type of weight is a much smaller amount of the total weight and is commonly referred to as “unsprung weight.” Unsprung weight is the weight of the landing gear components, being the landing gear strut, jack-screw mechanism, tire and brakes. The unsprung weight is virtually a constant and unchanging weight. Brake wear and tire wear are the only variations to unsprung weight; and in the consideration of the aircraft total weight, is a very minimal amount.

In the initial design and qualification of aircraft, there are four different aircraft structural weight limitations which are established. These weight limitations are predicated upon the structural design of the aircraft. Prior to each flight the pilot of the aircraft must assure throughout the operation of any flight that the aircraft remains within these structural weight limitations. The highest of these weight limitations is the “Maximum-Ramp Weight.” The Max-Ramp Weight limitation is the heaviest weight that the aircraft is allowed to taxi. This weight is slightly higher than the aircraft “Maximum Take-off Weight.” The higher Ramp Weight is to allow for the weight of fuel-burn, used for the aircraft to travel along airport taxi-ways, to the starting point of the aircraft take-off roll. The Maximum Take-off Weight is the heaviest weight at which the aircraft is allowed to take-off. The third weight limitation is the “Maximum Landing Weight” limitation, which is the heaviest weight at which and aircraft is designed for landing. The fourth weight limitation is the “Maximum Zero Fuel Weight” limitation, which is the maximum amount of cargo and payload that can be loaded inside the fuselage of the aircraft. Fuel, which is typically stored within the aircraft wing is not considered when determining Max-Zero Fuel Weight because when the fuel carried within the wing, that weight is being carried within a lifting portion of the aircraft, thus not applicable to the weight or loads carried within the non-lifting fuselage.

In a search of the prior art, there are numerous onboard aircraft weight and balance systems which measure aircraft weight and center of gravity. Research of the prior art to determine aircraft weight and balance systems can be divided into two basic strategies. One strategy is the method of measuring the pressure within the landing gear strut. The other being the method of measuring the amount of landing gear axle bending/deflection, as the aircraft weight increases. Both of these approaches are well documented and reference may be made to United States Patents:

#3,584,503 Senour
#3,701,279 Harris
#5,214,586 Nance
#5,521,827 Lindberg
#5,548,517 Nance
#6,128,951 Nance
#6,237,406 Nance
#6,237,407 Nance

U.S. Pat. No. 6,032,090 VonBose teaches the additional art of measuring landing gear strut friction which also uses the measurement of aircraft vertical acceleration in measuring aircraft landing gear strut seal friction.

U.S. Patent Application Publication # US/2006/0220918-A1 Stockwell teaches the additional art of rotating landing gear strut seals in a means to reduce landing gear strut seal friction, which is used to reduce frictional errors, in the measurement of aircraft weight.

The technology described in this application offers an alternate method and apparatus of measuring the aircraft weight by measuring the load which is transferred through the C-130 aircraft landing gear strut, and further through the jack-screw mechanism. The technology described herein is applicable as an improvement to existing prior art aircraft weight and balance measuring systems.

### SUMMARY OF THE INVENTION

A method of preparing a C-130 aircraft for weight measurements, which aircraft has main landing gear, each landing gear comprising a landing gear strut which extends and retracts by way of a jack-screw, the jack-screw being attached to the aircraft by at least one mounting bracket that receives the jack-screw and that bears on a friction washer. The friction washer is removed, and replaced with a through-hole load cell. The jack-screw extends into the load cell. The mounting bracket is allowed to bear on the load cell. The load cell from each main landing gear is coupled to a computer.

In one aspect, the respective jack-screw is attached to the aircraft by way of upper and lower mounting brackets, with the lower mounting bracket bearing on the load cell.

In accordance with another aspect, after allowing the mounting bracket to bear on the load cell, the aircraft is operated.

There is also provided a method of measuring the weight of a C-130 aircraft having main landing gear, with each of the main landing gear comprising a landing gear strut that extends and retracts by way of a jack-screw, the jack-screw attached to the aircraft by at least one mounting bracket. The load that the respective mounting bracket applies to the respective jack-screw is measured. The weight of the aircraft is determined from the measured loads.

In accordance with one aspect, the step of measuring the load that the respective mounting bracket applies to the respective jack-screw further comprises providing a load cell on each jack-screw and obtaining a load measurement from each load cell.

In accordance with another aspect, the aircraft is operated. In accordance with still another aspect, the measuring of the respective loads occurs while the aircraft is landing.

A weight measuring system for a C-130 aircraft comprises plural main landing gears, with each main landing gear having a tire and a telescoping strut. Each of the struts are coupled to a respective jack-screw. A motor rotates the respective jack-screw. The strut moves alongside the respective jack-screw when the motor rotates the respective jack-screw. The respective jack-screws are coupled to the hull of the aircraft by way of mounting brackets. The respective jack-screw having a lowermost stop. Each jack-screw has a load cell mounted thereto and located between the lowermost stop and the adjacent mounting bracket. A computer is coupled to the load cells.

In accordance with one aspect. the load cell is toroidal and is a washer as the jack-screw rotates.

### BRIEF DESCRIPTION OF THE DRAWINGS

Although the features of this invention, which are considered to be novel, are expressed in the appended claims, further details as to preferred practices and as to the further objects and features thereof may be most readily comprehended through reference to the following description when taken in connection with the accompanying drawings, wherein:

FIG. 1 is a side view of the front portion of a C-130 aircraft, where shown is the dual left main landing gear and single nose landing gear, in the extended position, resting on the ground.

FIG. 2 is a front view of a C-130 aircraft, shown with part of the fuselage cut away to illustrate the starboard/right main landing gear attached to the aircraft's jack-screw retraction mechanism.

FIG. 3 is a front view of a C-130 aircraft main landing gear, with the landing gear retraction jack-screw mechanism.

FIG. 4 is a perspective view illustrating the substitution of a typical thru-hole load cell to replace the existing friction washer component of the jack-screw mechanism.

FIG. 5 is a block diagram showing the components of the apparatus.

### DETAILED DESCRIPTION OF THE PREFERRED EMBODIMENT

A C-130 aircraft has an unusual type of mechanism for retracting and extending the main landing gear. Rather than rotating the main landing gear to retract them within the aircraft hull, a jack-screw mechanism is used to move the landing gear vertically along a longitudinal axis. A component of the jack-screw mechanism is a friction washer. The friction washer is located at the lowest point of the jack-screw mechanism and supports the compression loads which are transferred from the main landing gear tire, through the landing gear strut, further through the jack-screw mechanism, onto the airframe. The friction washer allows for easier rotation of the jack-screw and eliminates binding of the rotating elements.

As discussed herein, the friction washer is replaced with a thru-hole design load cell. The load cell will perform the same function of the friction washer but will also measure the compression loads that would be placed onto the friction washer while the aircraft landing gear are extended and the aircraft is resting on the ground. The load applied to the friction washer (now being a thru-hole load cell) is the “sprung weight” of the aircraft which is supported by that one of plural landing gear struts.

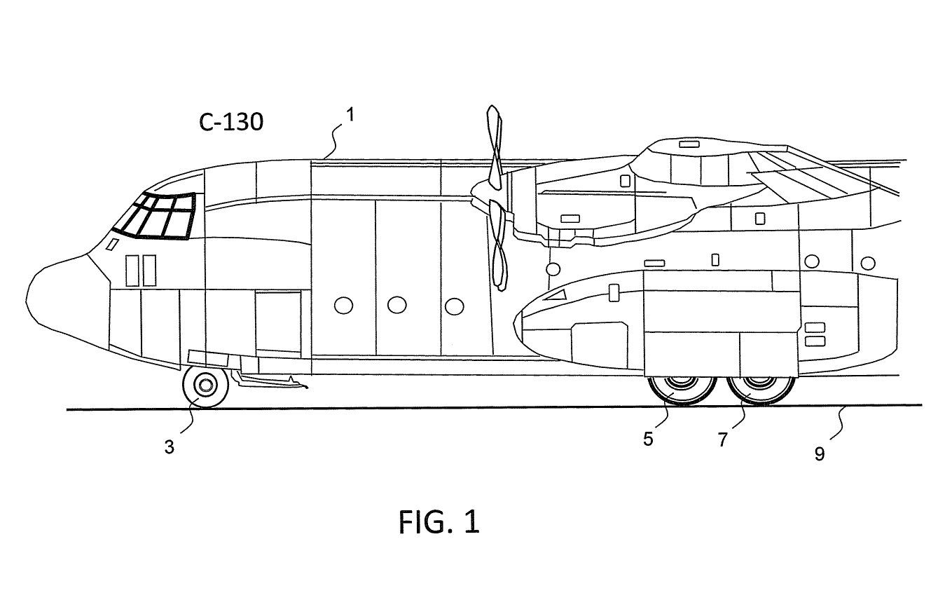

Referring now to the drawings, wherein like reference numerals designate corresponding parts throughout the several views and more particularly to FIG. 1 thereof, there is shown a side view of the front portion of a C-130 aircraft 1, with landing gear configuration consisting of a nose landing gear tire 3 and main landing gear, shown with one set of the two identical dual main landing gear with forward tire 5 and rear tire 7. Landing gear tires 3, 5 and 7 distribute the weight of the C-130 aircraft which is resting on the ground 9.

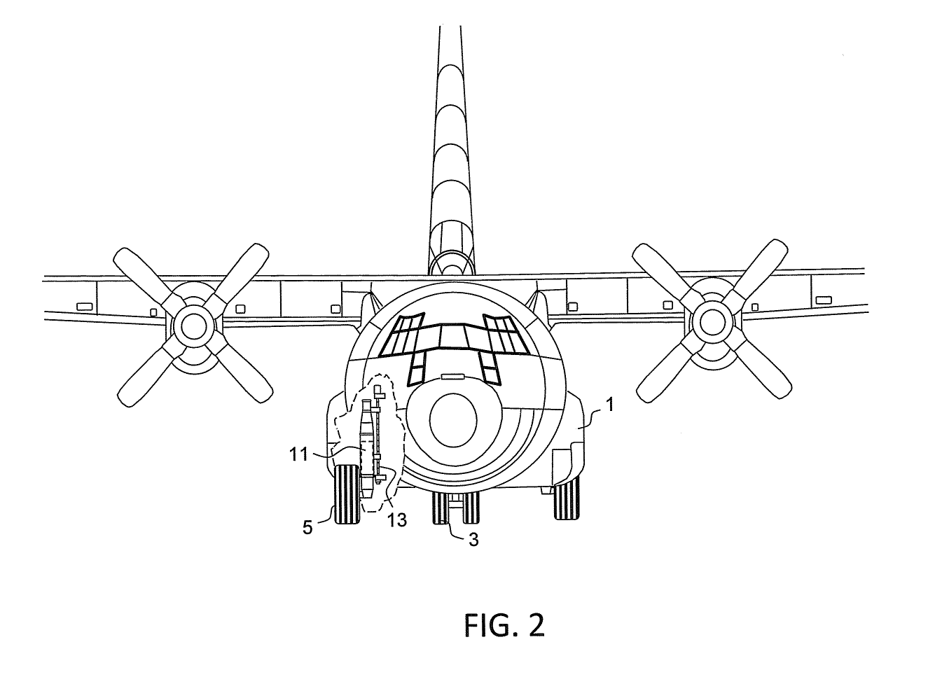

Referring now to FIG. 2 there is shown a front view of a C-130 aircraft 1, illustrating the starboard/right main landing gear 11 attached to the aircraft's jack-screw retraction mechanism 13, which is used to raise and lower the main landing gear 11 into and from the aircraft hull or fuselage 1.

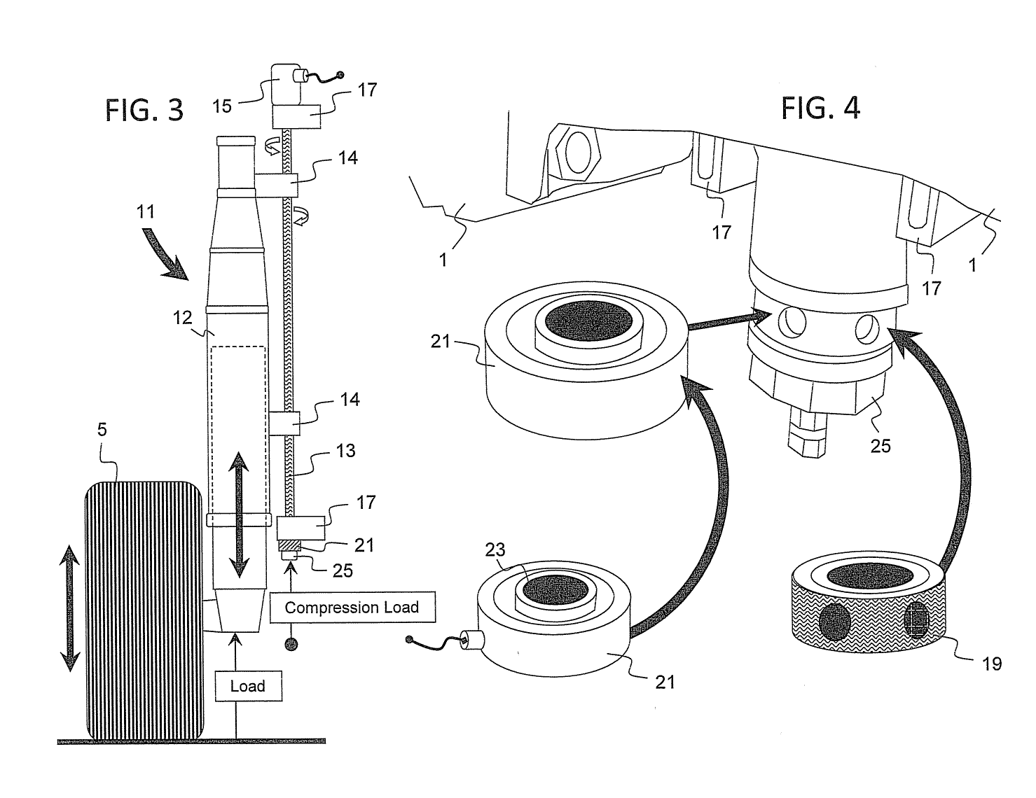

Referring now to FIG. 3 there is shown an enlarged front view of the forward starboard/right landing gear main landing gear 11, attached to the main landing gear retraction jack-screw mechanism 13. FIG. 3 shows the landing gear 11 and jack-screw mechanism somewhat schematically. The port/left forward and aft main landing gear are substantially the same. The landing gear 11 is a telescoping strut 12, having a piston movable within a cylinder. The strut 12 is coupled to the jack-screw 13. Jack-screw mechanism 13 rotates about its longitudinal axis and vertically raises and lowers main landing gear 11 from within the aircraft hull. Jack-screw 13 is a typical threaded rod and is rotated by a reversible electric motor 15 located at the top of jack-screw 13. As the jack-screw 13 rotates, main landing gear 11 will move vertically. The opposing curved arrows beneath reversible electric motor 15 illustrate the ability for both clockwise and counter-clockwise rotation of jack-screw 13. The jack-screw 13 is coupled to the strut 11 by upper and lower mounting brackets 14. Jack-screw mechanism 13 is attached to the aircraft hull by plural (upper and lower) mounting brackets 17. Located near the lowest point of the jack-screw 13 is a friction washer 19 (see FIG. 4). Friction washer 19 allows jack-screw 13 to freely rotate and reduces binding from the compression loads caused by the weight of the aircraft.

In the preferred embodiment friction washer 19 is replaced by a thru-hole load cell 21.

FIG. 4 illustrates that conventional friction washer 19 as it is removed from the landing gear and replaced with load cell 21. The load cell 21 is generally toroidal in shape having a center hole 23 therethrough. The bottom end of the jack-screw 13 is inserted into the hole 23. A nut or stop 25 (see FIG. 3) is coupled to the bottom end of the jack-screw and retains the load cell 21 thereon. The load cell 21 is between the stop 25 and the lowermost mounting bracket 17. Thru-hole load cell 21 will duplicate the function of the replaced friction washer 19. The load cell 21 allows the jack-screw 13 to freely rotate without binding. Thru-hole load cell 21 is commonly available from manufacturers such as Transducer Techniques with their THD series, or the Futek “Load Washer Load Cell” model # LLW480 with the ability to measure loads up to 125,000 pounds. The load cell 21 measures the load in the direction of the longitudinal axis of the jack-screw 13.

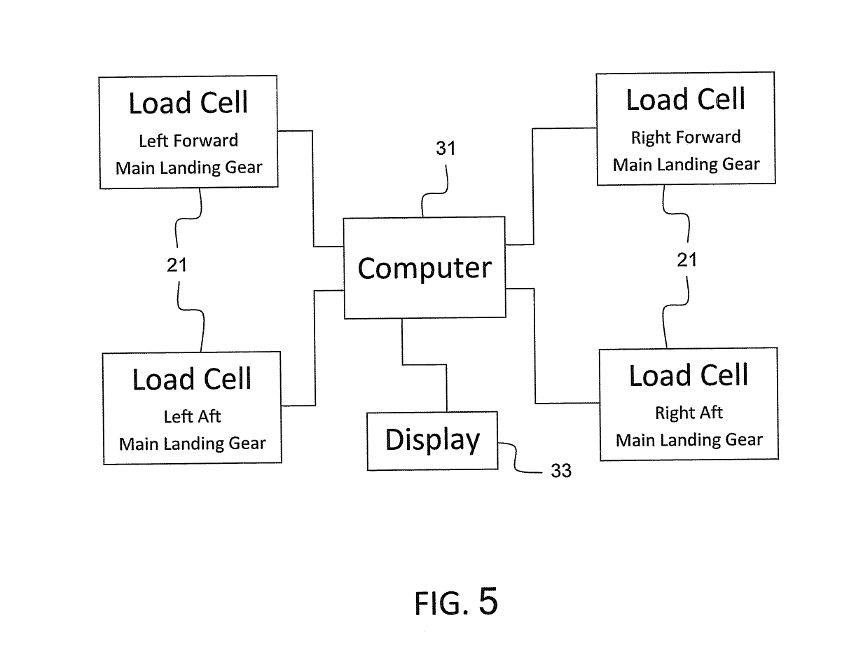

FIG. 5 shows four load cells 21 (a pair of load cells for the forward and aft right main landing gear and the other pair of load cells for the forward and aft left main landing gear) connected to a computer 31. The computer 31 has memory, a clock and a processor. The computer 13 is connected to a user interface such as a display 33, either by a wire or a wireless communications channel. The computer 31 is on board the aircraft. The display 33 or user interface is either on board the aircraft or is off the aircraft.

While the aircraft is resting on the ground, thru-hole load cell 21 will measure all compression loads generated by the weight of the aircraft being applied to the landing gear 11 jack-screw mechanism 13. The weight of the aircraft, and in particular, the sprung weight, bears on the load cells 21. The computer 31 takes measurements from the load cells. Such measurement can be initiated by an operator or can be automatically initiated. The computer 31 converts the compression load values from the load cells to a value equivalent to the supported aircraft weight, as measured in pounds or kilos.

In order to obtain a complete measurement of the aircraft weight, a measuring system, such as a pressure sensing system is used on the nose landing gear. Such pressure sensing systems for measuring weight in an aircraft landing gear strut are known in prior art. See Nance, U.S. Pat. Nos. 5,214,586; 5,548,517; 6,128,951; 6,237,406; 6,237,407, which disclosures are incorporated by reference herein. The aircraft weight is thus determined from the weights measured at all the landing gears and summed. The center of gravity is also determined accordingly.

The use of load cells 21 to measure aircraft weight and center of gravity provides a robust system that is easy to install and maintain. The weight measuring system can be installed and remain on the aircraft. The aircraft can be operated with the weight measuring system installed. Such operations include take-offs, flying, landings, taxiing, parked. Typically, weight measurement will be taken with the aircraft stationary and on the ground to minimize fluctuation in the measurement. Additionally, measurements from each of the four load cells can be taken while the aircraft is landing, to determine normal or possibly excess landing loads, which might be experienced by a hard landing event. Hard landings are common with the C-130 aircraft. The term used by the military operators for the event is often referred to as an “assault landing.” Such assault landing events create much higher loads onto the aircraft structure. The measurement and tracking of such assault landing events, by load cells 21, can be used in the life-cycle limitation monitoring of various C-130 structural components.

Additionally, as an exemplary embodiment of the invention has been disclosed and discussed, it will be understood that other applications of the invention are possible and that the embodiment disclosed may be subject to various changes, modifications, and substitutions without necessarily departing from the spirit and scope of the invention.

1. A method of preparing a C-130 aircraft for weight measurements, the aircraft having main landing gear, each landing gear comprising a landing gear strut which extends and retracts by way of a jack-screw, the jack-screw attached to the aircraft by at least one mounting bracket that receives the jack-screw and that bears on a friction washer, comprising the steps of:
a) removing the friction washer;
b) replacing the friction washer with a through-hole load cell, the jack-screw extending into the load cell;
c) allowing the mounting bracket to bear on the load cell;
d) coupling the load cell from each main landing gear to a computer.

2. The method of claim 1 wherein the respective jack-screw is attached to the aircraft by way of upper and lower mounting brackets, with the lower mounting bracket bearing on the load cell.

3. The method of claim 1 further comprising the step of, after allowing the mounting bracket to bear on the load cell, operating the aircraft.

4. A method of measuring the weight of a C-130 aircraft having main landing gear, each of the main landing gear comprising a landing gear strut that extends and retracts by way of a jack-screw, the jack-screw attached to the aircraft by at least one mounting bracket, comprising the steps of:
a) measuring the load that the respective mounting bracket applies to the respective jack-screw;
b) determining the weight of the aircraft from the measured loads.

5. The method of claim 4 wherein the step of measuring the load that the respective mounting bracket applies to the respective jack-screw further comprises providing a load cell on each jack-screw and obtaining a load measurement from each load cell.

6. The method of claim 4 further comprising the step of operating the aircraft.

7. The method of claim 5 further comprising the step of measuring the respective load, while the aircraft is landing.

8. A weight measuring system for a C-130 aircraft, comprising:
a) plural main landing gears, each main landing gear having a tire and a telescoping strut;
b) each of the struts coupled to a respective jack-screw;
c) a motor that rotates the respective jack-screw, wherein the strut moves alongside the respective jack-screw when the motor rotates the respective jack-screw;
d) the respective jack-screws are coupled to a hull of the aircraft by way of mounting brackets, the respective jack-screw having a lowermost stop;
e) each jack-screw having a load cell mounted thereto and located between the lowermost stop and the adjacent mounting bracket;
a computer coupled to the load cells.

9. The weight measuring system of claim 8, wherein the load cell is toroidal and is a washer as the jack-screw rotates.
